(19) United States
(12) Patent Application Publication
(10) Pub. No.: US 2014/0049767 A1
(43) Pub. Date: Feb. 20, 2014

(54) METHODS AND SYSTEMS FOR GEOMETRIC PHASE UNWRAPPING IN TIME OF FLIGHT SYSTEMS

(71) Applicants: Arrigo Benedetti, San Francisco, CA (US); Travis Perry, Menlo Park, CA (US); Mike Fenton, Palo Alto, CA (US); Vishali Mogallapu, Los Gatos, CA (US)

(72) Inventors: Arrigo Benedetti, San Francisco, CA (US); Travis Perry, Menlo Park, CA (US); Mike Fenton, Palo Alto, CA (US); Vishali Mogallapu, Los Gatos, CA (US)

(73) Assignee: MICROSOFT CORPORATION, Redmond, WA (US)

(21) Appl. No.: 13/586,391

(22) Filed: Aug. 15, 2012

(51) Int. Cl. G01C 3/08

(52) U.S. Cl. 356/5.1

(57) ABSTRACT

A phase-based TOF system is operated with N≧3 modulation frequencies fᵢ. These frequencies can be changed during N time intervals that together define an exposure time for the TOF pixel array. Preferably N=3 and modulation frequencies f₁, f₂, f₃ are used, where f₁=αm₁, f₂=αm₂, and f₃=αm₃, where m₁, m₂, and m₃ are small integers co-prime to each other, and a is a coefficent. A first phase image is acquired during perhaps the first third of exposure time using f₁, then for the next third of exposure time a second phase image is acquired using f₂, and then f₃ is used to acquire a third phase image during the last third of exposure time. Geometric analysis yields desired values for m₁, m₂, and m₃ to unwrap and thus disambiguate phase. Identification of valid and invalid data is identified using dynamically adjustable error tolerances.

### TECHNICAL FIELD

The application relates generally to phase-based time-of-flight (TOF) imaging systems that acquire depth images at distances (d) by comparing shift in phase (φ) between emitted modulated optical energy having modulation frequency f, and detected optical energy reflected by a target at distance d. More specifically, the application is directed to unwrapping (or dealiasing) the inherent ambiguity in phase-based TOF systems between detected values of phase shift (φ) and distance d.

### BACKGROUND

In phase-based TOF systems, changes in distance d produce changes in phase φ. The relationship between phase φ and distance d between the center of projection of the TOF system lens and the intersection between the optical ray and the surface of the target object seen by the TOF system sensor array is given by:

$$φ = \frac{4 π f}{c} d \qquad ( 1 )$$

where cis speed of light and f is modulation frequency. But φ can only vary between 0 and 2·π, and at best distance d is known modulo 2·π·c/2·ω=c/2·f. Consequently the maximum distance dₘₐₓ that is known without ambiguity and without further processing is given by:

$${d}_{ma x} = \frac{c}{2 f} \qquad ( 2 )$$

From equation (2) it is clear that increasing modulation frequency f in a TOF system decreases operating range distance dₘₐₓ over which φ correlates uniquely to d. For example at f=50 MHz, a TOF system will have dₘₐₓ≈3 M, whereas decreasing modulation frequency to f=20 MHz increases dₘₐₓ to about 7.5 M, e.g., a factor of 50/20, or 2.5/1. But for maintaining acquired depth data of similar quality at 20 MHz, it may be desirable to increase TOF system optical output power by 6.25×, i.e., 2.5×2.5. U.S. Pat. No. 7,791,715 (2010) to Bamji, assigned to Microsoft, Inc., assignee herein, describes a phase-based TOF system that seeks to unwrap d as a function of φ using two modulation frequencies f₁, f₂ each close to the TOF system maximum modulation frequency fₘ. Use of the two relatively high modulation frequencies per U.S. Pat. No. 7,791,715 (“the '715 patent”) created virtual modulation frequencies resulting from a quasi-mixing process that resulted in an increased fₘₐₓ while preserving high modulation frequencies.

FIG. 1A depicts a TOF system 10 as described in the '715 patent. TOF system 10 determines distance d to target object 20 by emitting active optical energy Sₒᵤₜ=cos(ω·t) from optical source 30, and by analyzing a fraction (A) of the target object reflected-back energy Sᵢₙ=A·cos(ω·t+φ). Energy Sᵢₙ, which is always positive and may be considered to have an offset of +1, falls upon a sensor array 40 whose pixels can detect the incoming energy under command of electronics system 50. Pixel readout and signal processing preferably occurs at specific phase regimes, e.g., 0°, 90°, 180°, 270° associated with optical source 30, although other phase regimes could instead be used. System 50 helps process detection signals, and also provides storage, clock control timing, input/output functions, and controls signal generator 60, whose output drives optical source 30. TOF system 10 generates an OUTPUT signal that can include three-dimensional depth data to target object 20, among other data. FIG. 1B depicts the interplay between a higher modulation frequency f₁ and its associated small dₘₐₓ₁, and a lower modulation frequency f₂ and its associated larger dₘₐₓ₂. In FIG. 1B the slope φ/d associated with f₂ is less than the slope associated with f₁, which means errors in phase acquired at f₂ translate to greater errors in detected distances. FIG. 1C depicts a much larger dₘₐₓ realized by use of two modulation frequencies (50 MHz, 31 MHz) according to the '715 patent, where f_{D}, f_{E}, and f_{DS} are virtual modulation frequencies.

The ratio f_{E}/f_{D} acts as a noise coefficient factor, and noise associated with phase φ_{D} increases by this ratio. Thus an increased ratio f_{E}/f_{D} represents amplified noise in φ_{D} and is undesired as it contributes to an incorrect dealiasing or unwrapping decision. Advantageously, acquiring data using two relatively high frequency modulation frequencies per the '715 patent averages phase data measurement noise, which enhances signal/noise performance for the TOF system. TOF systems that can disambiguate range using data acquired with modulation frequencies close to maximum modulation frequency fₘ are said to be relatively lossless.

However further improvement in extending dₘₐₓ would be useful. In addition, it may be desirable for a real-time method to sense TOF system acquisition data so as to dynamically vary value of error tolerances to minimize the probability of introducing errors during the unwrapping process. The present application provides a method and system for so doing.

### SUMMARY

A phase-based TOF system is operated with at least two and preferably with N=3 modulation frequencies fᵢ. These frequencies can be changed during N equal time intervals that together define an exposure time for the TOF pixel array. In embodiments of the present application, preferably N=3 and modulation frequecies f₁, f₂, f₃ are used, where f₁=am₁, f₂=am₂, and f₃=am₃, where m₁, m₂, and m₃ are small integers co-prime to each other, and α is a coefficent.

According to embodiments of the present application in which N=3, a first phase image is acquired during the first third of the exposure time using f₁, then for the next third of the exposure time a second phase image is acquired using f₂, and then f₃ is used to acquire a third phase image during the last third of the exposure time. In these embodiments m₁, m₂, and m₃ are co-prime numbers.

For N=3, the unwrapping problem may be conceptualized as being related to an N-sided figure, here a three-dimensional geometric figure, i.e., a cube, having sides that measure π. A total of m₁+m₂+m₃₋₂ wrapping segments lie within this cube parallel to the three-dimensional vector defined as:

$$v = [ \begin{matrix}{m}_{1} \\ {m}_{2} \\ {m}_{3}\end{matrix} ] ,$$

Indicator segments are identified and a rotation matrix is computed, and the rotation is applied to the wrapped phases. Noise-corrupted phase measurements (φ₁, φ₂, φ₃) can be projected onto the plane orthogonal to v, which brings the φ₃ coordinate axis parallel to v. So doing reduces a three-dimensional analysis to a two-dimensional analysis, advantageously reducing computational time and overhead. So doing identifies indicator points and corresponding aliasing intervals. In some embodiments an optimized rotation matrix preferably is computed and applied to the indicator segments before identifying the indicator points and corresponding aliasing intervals.

Preferably during runtime operation of the TOF system input phase data is rotated to find closest indicator points to line segments. In some embodiments these points can be labeled as valid or invalid based upon their computed distance from an indicator point, with validity confidence being determined by a static or by a dynamic threshold test. The unwrapping interval associated with each indicator point is used to unwrap the phase measurements, which measurements preferably are averaged, which averaging also reduces noise magnitude in the phase data.

The applied geometric analysis results in optimal selection of m₁, m₂, and m₃ to unwrap and disambiguate phase for the TOF system. The ability to dynamically assign confidence labels to acquired phase data can advantageously reduce motion blur error due to target objects that move during data acquisiton using N modulation frequencies.

Other features and advantages of the application will appear from the following description in which the preferred embodiments have been set forth in detail, in conjunction with their accompanying drawings.

### BRIEF DESCRIPTION OF THE DRAWINGS

FIG. 1A is a block diagram depicting an exemplary TOF system as used with the '715 patent, according to the prior art;

FIG. 1B depicts φ vs. d for two modulation frequencies and demonstrates effect of modulation frequency upon dₘₐₓ, according to the prior art;

FIG. 10 depicts φ vs. d for two close modulation frequencies and for virtual frequencies f_{D}, f_{E}, and f_{DS}, and resultant large dₘₐₓ, per the 715 parent, according to the prior art;

FIGS. 2A-2D depict phase φ vs. distance d for various steps in hierarchical unwrapping (or dealiasing), according to embodiments of the '484 application;

FIG. 3 depicts a TOF system, according to embodiments of the present application;

FIG. 4 depicts a plot of phase φ_{ω}[i] vs. distance d, according to embodiments of the present application;

FIG. 5 depicts a plot of φ_{ω1}[i] vs. distance d, according to embodiments of the present application;

FIG. 6 depicts a plot of φ_{ω2}[i] vs. φ_{ω1}[i], according to embodiments of the present application;

FIG. 7A depicts three-dimensional non-axis geometric points helpful to better understanding phase unwrapping and depicts non-axis-aligned points, according to embodiments of the present application;

FIG. 7B depicts axis aligned geometric points having two-dimensional coordinates for noisy phase data, according to embodiments of the present application;

FIG. 7C depicts axis aligned geometric points having two-dimensional coordinates wherein threshold labeling of data points reduces the effect of noise on phase data, according to embodiments of the present application;

FIG. 8 depicts exemplary static and dynamic zones defined in a jitter vs. signal amplitude plot, useful in assigning confidence labels to phase data, according to embodiments of the present application;

FIG. 9 is a flow chart depicting initialization method steps used to identify indicator points and corresponding aliasing intervals in a TOF system, according to embodiments of the present application; and

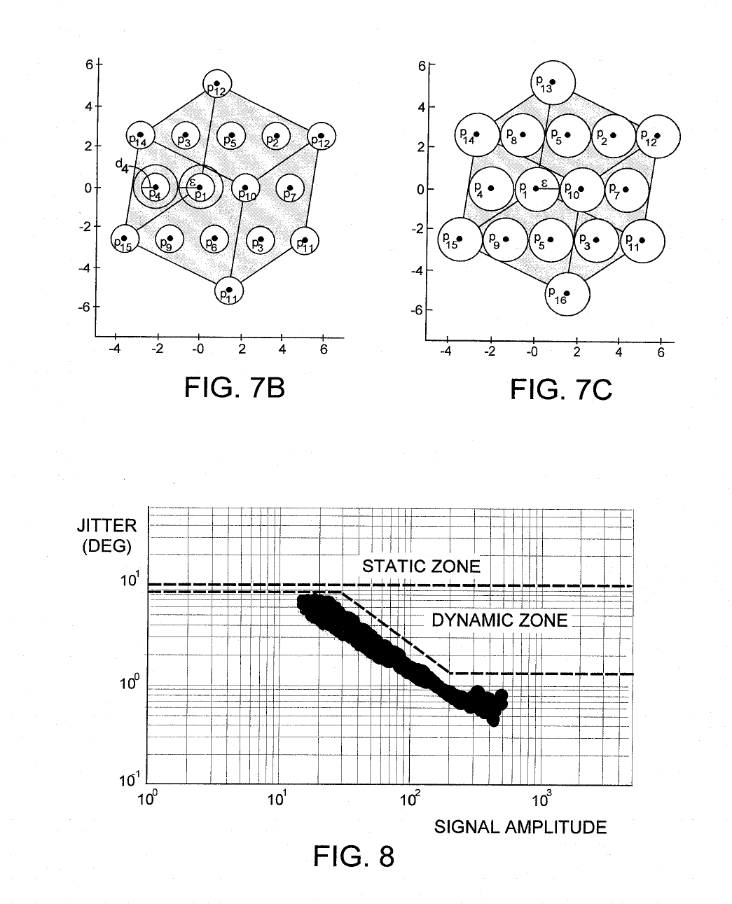

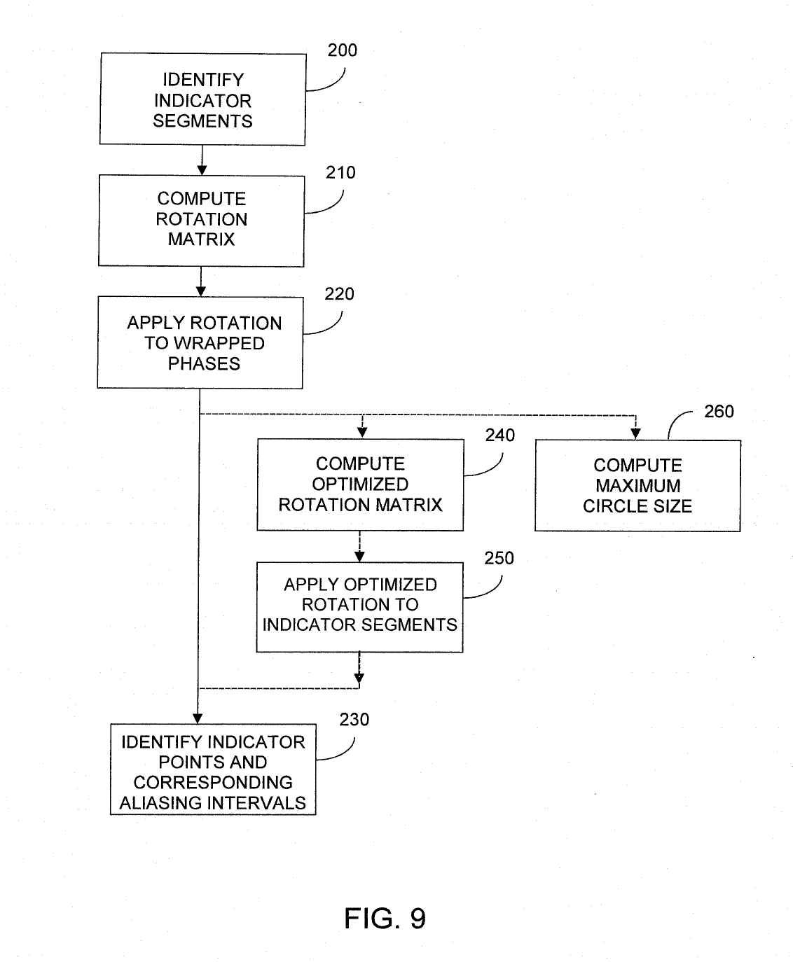

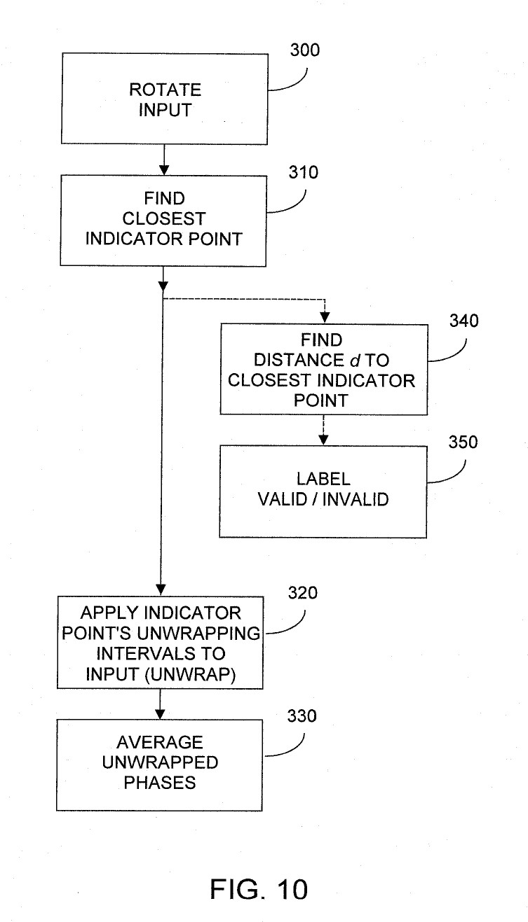

FIG. 10 is a flow chart depicting phase unwrapping steps applied during real-time operation of a TOF system, according to embodiments of the present application.

### DETAILED DESCRIPTION

Co-pending U.S. patent application Ser. No. 13/021,484 (US Patent Application Publication Number 2011/0188028) by Hui and Bamji, entitled “Methods and Systems for Hierarchical De-Aliasing Time-Of-Flight (TOF) Systems” and assigned to Microsoft, Inc., assignee herein, describes improvements to U.S. Pat. No. 7,791,715—both of which are incorporated herein by reference. It will be appreciated that a challenge in designing and operating a TOF system is to maintain a small ratio f_{E}/f_{D} while achieving a desired range dₘₐₓ associated with small f_{D} and a precision of depth associated with a large f_{E}. Some embodiments in the '484 application employ an n-step hierarchical approach to unwrapping, to minimize problems associated by a large amplification of noise in phase φ_{E}. Other embodiments of the '484 application apply a two-step hierarchical approach while operating the TOF system using three modulation frequencies.

Assume there are m modulation frequencies f₁, f₂, . . . , fₘ (f₁>f₂> . . . , >fₘ), and it is desired that the TOF system achieve unambiguous range d_{D}, which corresponds to frequency f_{D} as in

$${d}_{D} = \frac{φ c}{4 π {f}_{D}} .$$

One embodiment in the '484 application uses f_{D} to de-alias and to achieve the distance resolution of the effective frequency f_{E}, where f_{E}=g₀ (f₁, f₂, . . . , fₘ) is a function of the modulation frequencies f₁, f₂, . . . , fₘ, preferably an arithmetic mean or a weighted average.

Rather than use f_{D} to dealias or unwrap phase for effective frequency f_{E} in a single step, preferably a set of N−1 intermediate frequencies is generated f_{DE1}, f_{DE2}, f_{DE(N-1)}) where f_{D}<f_{DE1}<f_{DE2}< . . . <f_{DE(N-1)}<f_{E} and where f_{D}<f_{DE1}<f_{DE2}< . . . <f_{DE(N-1)}<f_{E}. Each of the intermediate frequencies is a function of the modulation frequencies f₁, f₂, . . . , fₘ as in

f_{DEk}=gₖ(f₁, f₂, . . . , fₘ) where k=1, 2, 3, . . . , N−1.
f_{DEk}=gₖ(f₁, f₂, . . . , fₘ) where k=1, 2, 3 . . . , N−1. Let f_{DE0}=f_{D}, and let f_{DEN}=f_{E}.

At each step of this hierarchical de-aliasing or unwrapping, dealiasing of the phase φ_{DEk} of f_{DEk} occurs using phase φ_{DE(k+1)} of f_{DE(k+1)} (k=0, 1, . . . N−1) by finding the correct de-aliasing interval mₖ such that φ_{DEk}_{_{—}}_{scaled}≅φ_{DE(k+1)}+mₖ2π, wφ_{DEk}_{_{—}}_{scaled}≅φ_{DE(k+1)}mₖ2π where

$$φ = \frac{{f}_{DE ( k + 1 )}}{{f}_{DEk}} {φ}_{DEk} .$$

The final unwrapped phase for f_{E} is:

$${φ}_{E} + {m}_{N - 1} 2 π + {m}_{N - 2} \frac{{f}_{DE ( N - 1 )}}{{f}_{DE ( N - 2 )}} 2 π + … + {m}_{k} \frac{{f}_{DE ( k + 1 )}}{{f}_{DEk}} 2 π + … + {m}_{1} \frac{{f}_{DE 1}}{{f}_{D}} 2 π .$$

The number of the intermediate frequencies N−1 and the ratio

$$\frac{{f}_{DE ( k + 1 )}}{{f}_{DEk}}$$

between frequencies in each consecutive pair preferably are determined by the uncertainty of the depth. Preferably uncertainty of the amplifying factor at each step is sufficiently small such that the probability of choosing mₖ incorrectly is low.

The use of three modulation frequencies in a TOF system will now be described with reference to FIGS. 2A-2D. For two-step hierarchical de-aliasing, at least N=3 modulation frequencies may be used. The total unambiguous range of the system is determined by f_{D}, which is a function of the three modulation frequencies. As indicated by FIG. 10, first phase φ_{D}=can be used for f_{D} to de-alias phase φ_{DE} of intermediate frequency f_{DE}, and the correct de-aliasing interval m for φ_{DE} such that, φ_{DS}≅φ_{DE}+m2π.

In a second hierarchical de-aliasing step, each de-aliasing interval of φ_{E} is used to de-alias the effective phase φ_{D} of effective frequency f_{E} by finding the correct de-aliasing interval n such that φ_{DS}≅φ_{E}+n2π. Referring now to FIGS. 2A-2D, combining the two de-aliasing steps enables determination of the final de-aliased values for φ_{E} as

$${φ}_{E} + n 2 π + m \frac{{f}_{DE}}{{f}_{D}} 2 π .$$

Note that the amplification ratio for the de-aliasing steps are

$$\frac{{f}_{DE}}{{f}_{D}} and \frac{{f}_{E}}{{f}_{DE}}$$

respectively. Advantageously, this method achieves the desired large ratio

$$\frac{{f}_{E}}{{f}_{D}} = \frac{{f}_{DE}}{{f}_{D}} \times \frac{{f}_{E}}{{f}_{DE}}$$

without amplifying the noise in φ_{E} by such a large ratio. The beneficial result occurs because the de-aliasing intervals m and n are determined separately and the noise is amplified by a much smaller ratio at each method step.

Let the three modulation frequencies be f₁, f₂ and f₃. Embodiments of the '484 application seek to achieve an effective frequency f_{E} that is as close as possible to the TOF system maximum modulation frequency fₘ. Let f_{D}=f₁−f₂ be designated as the slowest frequency associated with the total dealiasing range, and let f_{DE}=f₁−f₃ be designated as the intermediate frequency. The final effective frequency can be

$${f}_{E} = \frac{{f}_{1} + {f}_{2} + {f}_{3}}{3}$$

or other weignted linear combination of f₁, f₂ and f₃.

Referring to FIG. 2A, one can first use phase φ_{D} for frequency f_{D} to dealias phase φ_{DE} of some intermediate frequency f_{DE} and the correct dealiasing interval m for phase φ_{DE} such that φ_{DS}≅φ_{E}+m2π. Referring to FIG. 2B, each dealiasing interval φ_{DE} can be used to dealias effective phase φ_{E} of effective frequency f_{E} by finding the correct dealiasing interval n, such that φ_{DES}≅φ_{E}+n2π. FIGS. 2C and 2D depict how to dealias phase φᵢ of individual frequency fᵢ (i=1, 2, or 3, for three frequencies), using phase φ_{DES} For example, FIG. 2C shows that φ_{DE} and φᵢ are likely to wrap around at different distances. Thus one cannot dealias phase more than the first cycle of φ_{DE}. (To dealias φ_{DS} as shown in FIG. 2A, one would have to dealias φ_{DE} for all of the four cycles shown in the figure.) FIG. 2D shows that one can compute the offset-corrected phase φ_{offset}, which will always start at zero phase at the beginning of each cycle of φ_{DES}. One can then use this offset-compensated phase to dealias phase φᵢ over the multiple cycles of φ_{DES}. Thus, a first method step is to dealias f_{DE}=f₁−f₃ using f_{D}=f₁−f₂. Let φ₁ be phase of f₁, let φ₂ be phase of f₂, and let φ₃ be phase of f₃. First φ₁ is unwrapped using φ₂ to get φ₁^{unwrap-2}, φ₁^{unwrap-2}=φ₁^{unwrap-2}=φ₁+2π*(φ₁<φ₂), and unwrap φ₁ using φ₃ to get φ₁^{unwrap-3}. One can then obtain phase for f_{D}=f₁−f₂ as φ_{D}=φ₁^{unwrap-2}−φ₂ and one can obtain phase for f_{DE}=f₁−f₃ as φ_{DE}=φ₁^{unwrap-3}−φ₃.

One can now rescale φ_{D} to the same slope as φ_{DE} and create φ_{DS}, where

$${φ}_{DS} = \frac{{f}_{DE}}{{f}_{E}} {φ}_{D} = \frac{{f}_{1} - {f}_{2}}{{f}_{1} - {f}_{2}} {φ}_{D} .$$

Completing the first step, one can next find the correct dealiasing interval m by minimizing

$$\vert {φ}_{DS} - ( {φ}_{DE} + m 2 π ) \vert$$

for m=0, 1, 2, . . . . . Consider next step two, which involves dealiasing

$${f}_{E} = \frac{{f}_{1} + {f}_{2} + {f}_{3}}{3}$$

from f_{DE}=f₁−f₃. Although it is desired to dealias f_{E}, one cannot get the phase corresponding to

$${f}_{E} = \frac{{f}_{1} + {f}_{2} + {f}_{3}}{3 }$$

with the correct wrapping-around method. Instead embodiments of the '484 application dealias f₁, f₂ and f₃ separately and get the unwrapped phases φ₁=φ₁+n₁2π, φ₂=φ₂+n₂2π, and φ₃=φ₃+n₃2π.

Unwrapped phase for

$${f}_{E} = \frac{{f}_{1} + {f}_{2} + {f}_{3}}{3}$$

can be calculated as

$${φ}_{E} = \frac{{φ}_{1} + {φ}_{2} + {φ}_{3}}{3} .$$

FIG. 2C and FIG. 2D are useful in understanding dealiasing fᵢ (i=1, 2, 3) to get unwrapped phase φᵢ. As shown in FIG. 2C, θ_{DE} and θᵢ are likely to wrap around at different d distance because of the frequency differences. This will cause problems in the second step of dealiasing unless additional constraints on the frequencies are imposed, e.g., φᵢ is a multiplier of φ_{DE}. Otherwise, directly applying the dealiasing method as the first step to dealias φᵢ using φ_{DE}, would only dealias the first cycle of θ_{DE}. This restriction occurs because in the remaining cycles, φᵢ and φ_{DE} will not start at the same position and one cannot satisfy the relationship of φ_{DES}≈φᵢ+nᵢ2π.

FIG. 2D demonstrates use of an “offset compensation” to avoid adding additional constraints that limit the choices of frequencies. First one can remove the offset of φᵢ caused φᵢ by the wrapping around of φ_{DES} and φ_{DES} and compute the offset-corrected phase φᵢ^{offset}. The offset-corrected phase θᵢ^{offset} will always start at zero phase at the beginning of each cycle of φ_{DES}. One can then find the correct de-aliasing interval by minimizing:

|φ_{DES}−(φᵢ^{offset}+nᵢ2π)| for nᵢ=0, 1, 2, . . . where i=1, 2, 3

The unwrapped phase for each frequency fᵢ is computed as:

$${φ}_{i} = {φ}_{i}^{offset} + {n}_{i} 2 π + m \frac{{f}_{DE}}{{f}_{D}} 2 π$$

The unwrapped phase for

$${f}_{E} = \frac{{f}_{1} + {f}_{2} + {f}_{3}}{3} is then {φ}_{E} = \frac{{φ}_{1} + {φ}_{2} + {φ}_{3}}{3} .$$

The above described hierarchical dealiasing methods preferably used at least three close-together modulation frequencies and created a low dealiasing frequency and at least one intermediate frequency to successfully dealias an increased disambiguated distance dₘₐₓ for a TOF system. Further unlike two-frequency dealiasing, the methods described in the '484 application amplified noise by only a small ratio coefficient at each dealiasing step. But while the methods described in the '484 application represent substantial improvements in dealiasing or unwrapping phase, it is difficult for the TOF system to know in real-time how best to dynamically make corrections to further reduce acquisition error. In one sense, the analyses associated with the '484 application are simply too complicated to provide a real-time sense of how to further improve quality of the data stream being output by the TOF system sensor array.

As will now be described, embodiments of the present application enable substantially lossless phase unwrapping (or dealiasing), using multiple modulation frequencies, while providing a mathematical graphical analysis useable to make real-time dynamic adjustments to the TOF system.

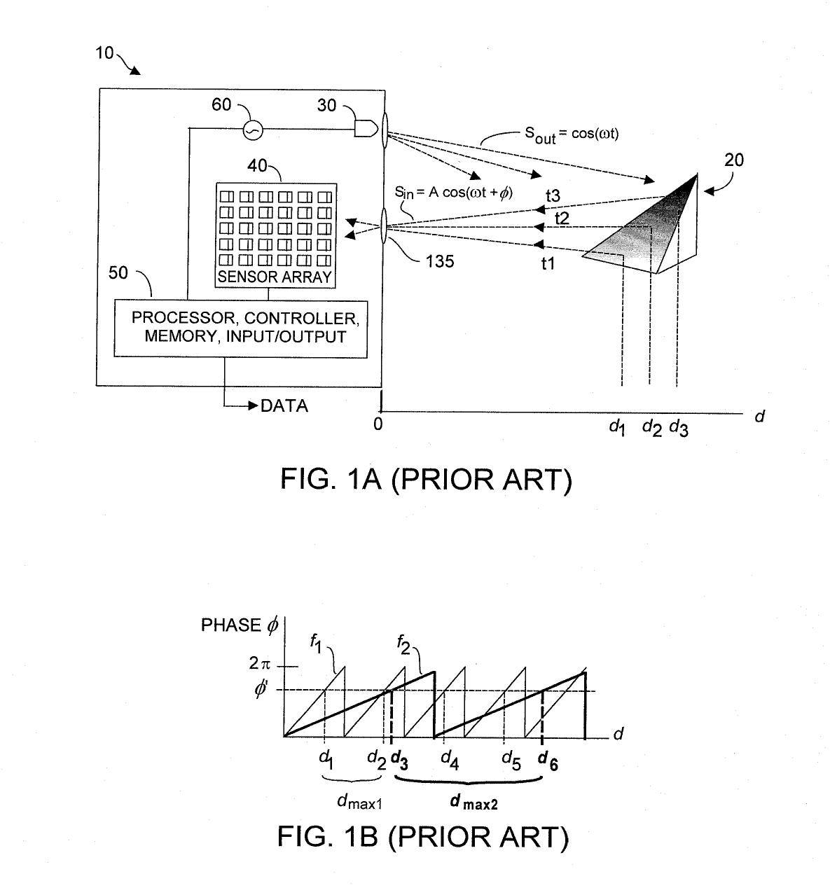

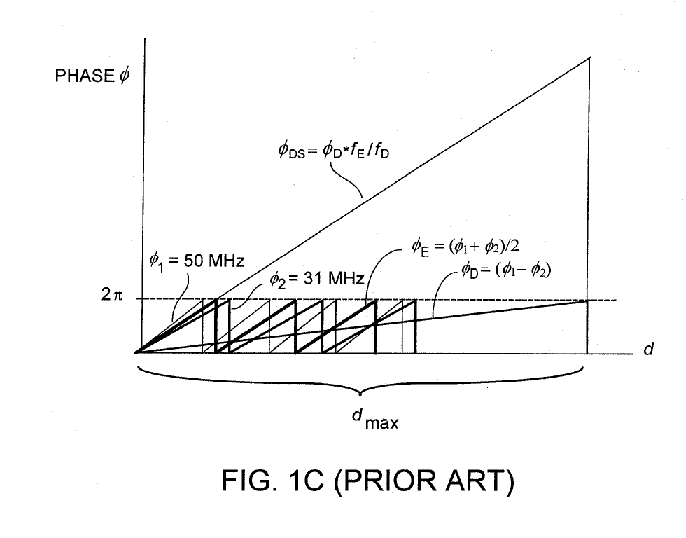

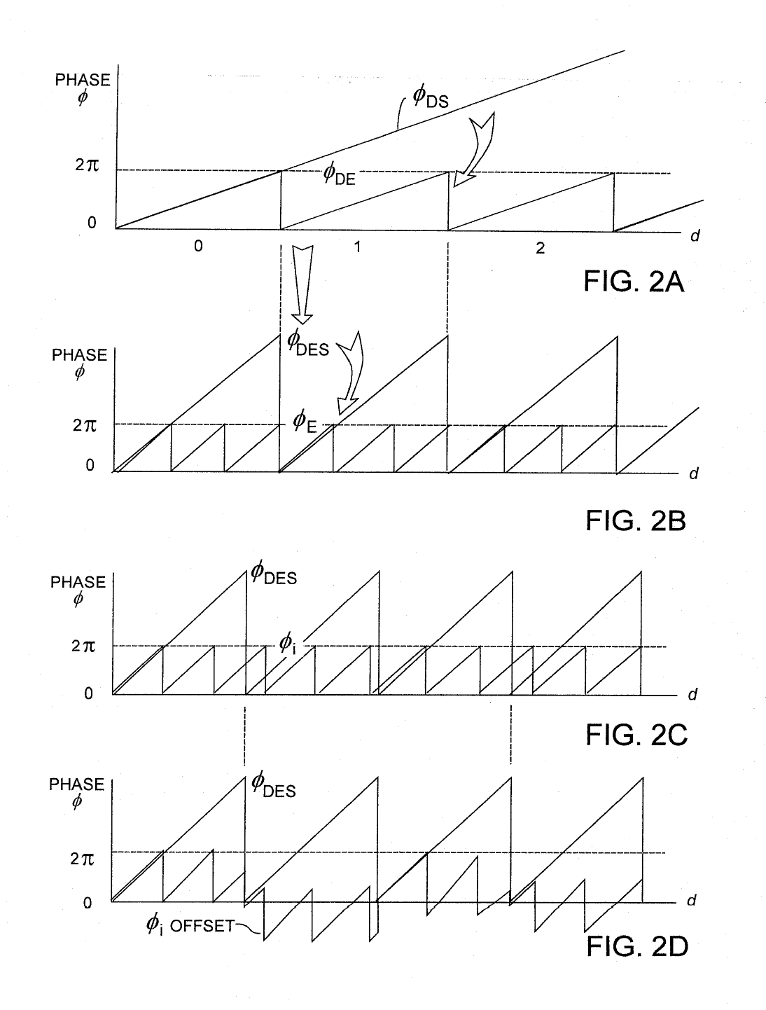

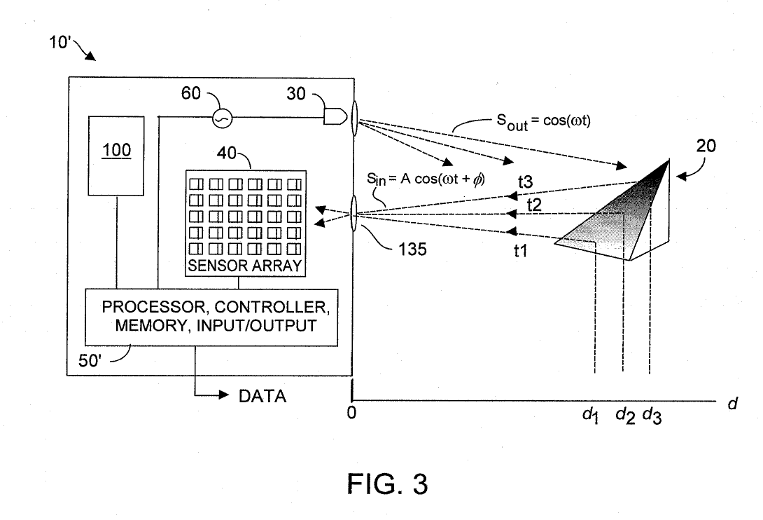

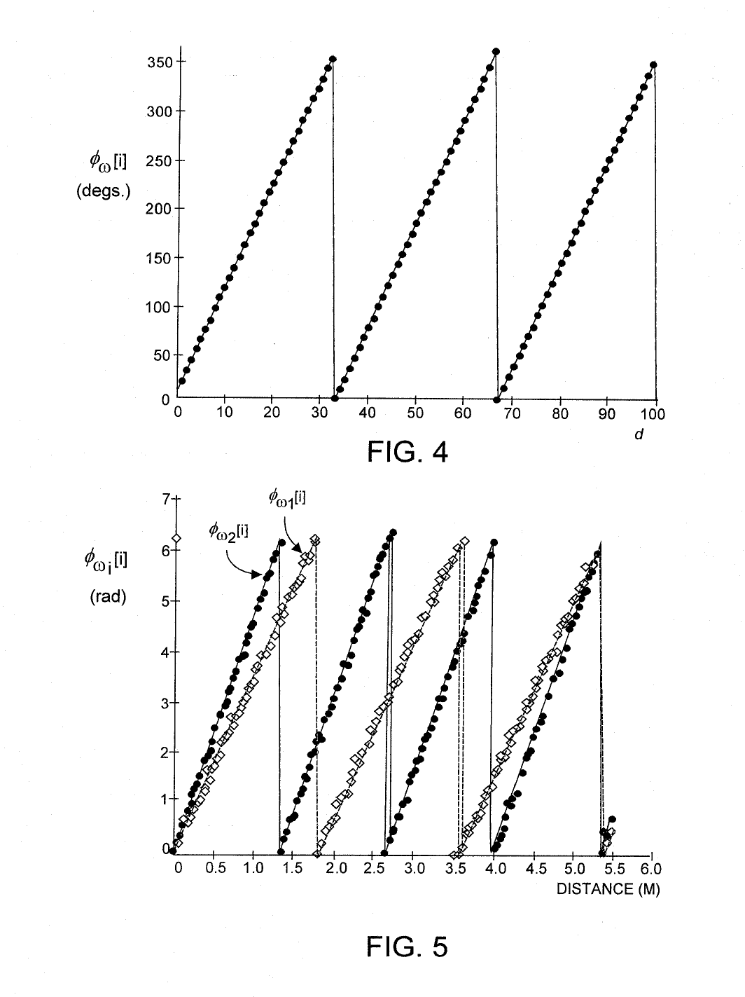

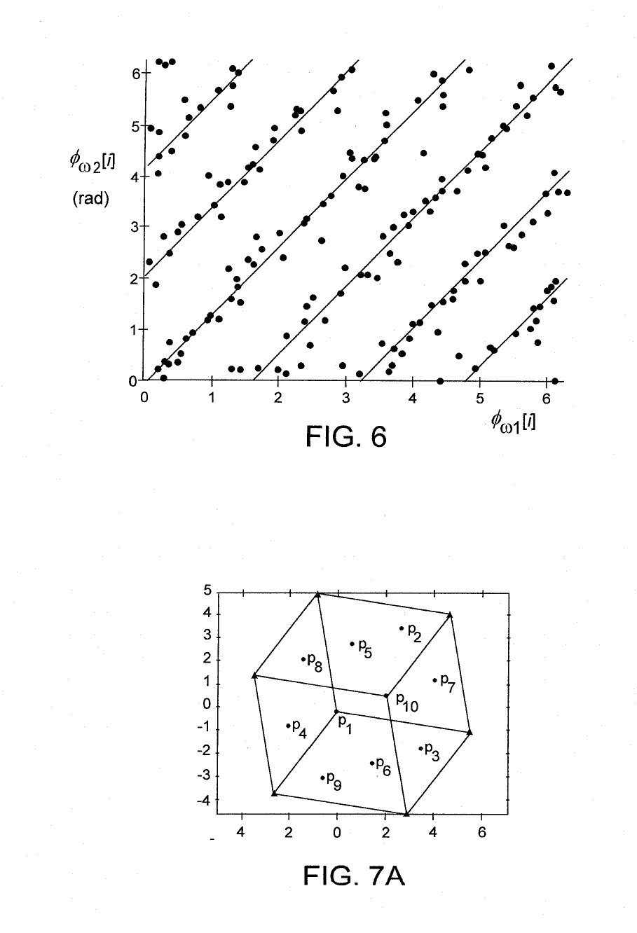

TOF system 10′ in FIG. 3 is similar to the TOF system 10 depicted in FIG. 1A but for the inclusion of processor and dynamic error correction module 100, and modification to the processor, controller, memory, input/output electronic system, denoted as 50′ in FIG. 3. Module 100 preferably carries out data processing and storage, necessary to carry out the analyses described below, although portions or all of the storage and analyses could instead be carried out within system 50′. Typically module 100 will include at least a graphics processing unit, a CPU, and memory functions.

As noted earlier, d is known modulo c/2·f. The phase φ measured by the TOF sensor array 40 is said to be wrapped to the interval [0,2π[ and the largest disambiguated range distance dₘₐₓ may be termed the wrapping distance. It is useful to write the relation between phase φ as defined in equation (1) and wrapped phase φ_{w} as:

φ=φ_{w}+2πn(d) (3)

where n(d) is often called the indicator function. According to the present application, phase unwrapping is concerned with the computation of the indicator function. The relation between wrapped and unwrapped phase can be made explicit by the wrapping operator:

φ_{w}=W[φ] (4)

Phase unwrapping is an ill-posed problem, since equation (3) has infinite solutions. However one can unwrap a discrete sequence of phase samples φ[i] based on the observation that if

−π≦∇{φ[i]}≦π (5)

it is possible to show that

∇{φ[i]}=W{∇{W{φ[i]}}}=W{∇{φ_{w}[i]}} (6)

where ∇ denotes the first order difference of a discrete sequence:

∇x[i]=x[i+1]−x[i].

The unwrapped sequence φ[i] can be recovered by the wrapped phase samples φ_{d}[i] by integration:

$$φ [ m ] = φ [ 0 ] + {\sum }_{i = 0}^{m - 1} W \{ ∇ \{ {φ}_{w} [ i ] \} \} . \qquad ( 7 )$$

While the above-described unwrapping method is straightforward it unfortunately fails in most practical cases. Failure occurs because equation (5) is not satisfied, typically for several reasons incuding the presence of noise, and the absence of adequate signal bandlimiting. Methods for overcoming these limitations will now be described.

Embodiments of the present application employ a phase unwrapping algorithm that uses N multiple modulation frequencies and functions adequately in most real world applications. In these embodiments, the modulation frequency of active optical source 30 (see FIG. 3) is set by electronic system 50′, which also governs operating regimes of the pixel sensors in TOF sensor array 40. The modulation frequency is dynamically changed during sensor array acquisition of an image frame, which is to say the sensor array exposure time to incoming optical energy Sᵢₙ is divided into N parts whose sum equals the exposure time T for the sensor pixel array. During the first part of the N parts, system 50′ and/or module 100 set the modulation frequency of active optical source 30 to f₁ and acquire the first phase image. During the second part, the active light modulation frequency is set to f₂ and the second phase image is acquired, and so on. While the described method is applicable to use of at least two (N≦2) modulation frequencies, in practice use of N=3 modulation frequencies sufficies, and is easier to implement in a TOF system than N>3 modulation frequencies. In some embodiments, the N parts may be of equal time duation.

FIG. 4 demonstrates this aspect of the present application, for the case of N=100 samples taken for a one-dimensional linear ramp distance signal, dₘᵢₙ=10 cm, and dₘₐₓ=4.5 m.

$$d [ i ] = {d}_{m i n} + \frac{{d}_{m ax} - {d}_{m i n}}{N - 1} i , \\ i = 0 , … , N - 1. \qquad ( 8 )$$

A single instance of the ramp signal is shown in the φ_{ω}[i] vs. i plot of FIG. 4. For a single modulation frequency, the wrapping distance U is:

$$U = \frac{c}{2 f} . \qquad ( 9 )$$

Consider now the case of two different modulation frequencies f₁ and f₂, where f₁<f₂. It is assumed for each data point d[i] the pixel sensor array will produce two phase value according to

$$\begin{matrix}{φ}_{w 1} [ i ] = ( \frac{4 π {f}_{1}}{c} d [ i ] + {w}_{1} [ i ] ) mod 2 π , & ( 10 ) \\ {φ}_{w 2} [ i ] = ( \frac{4 π {f}_{2}}{c} d [ i ] + {w}_{2} [ i ] ) mod 2 π . & ( 11 )\end{matrix}$$

where w₁[i], w₂[i] are independent and identically distributed noise terms drawn from a zero-mean Gaussian distribution with variances σ₁, σ₂.

FIG. 5 is a plot of wrapped phase data φ_{w1}[i], φ_{w2}[i]vs. distance for noisy ramp signals that are wrapped, where f₁=84 MHz, f₂=112 MHz, m₁=4, m₂=3, σ₁=σ₂=5 degrees, dₘᵢₙ=0 m, and dₘₐₓ=5.5 m.

FIG. 6 is a two frequency phase plot of φ_{w2}[i] vs. φ_{w1}[i], where f₁=84 MHz, f₂=112 MHz, σ₁=σ₂=10 degrees, dₘᵢₙ=0 m, and dₘₐₓ₌5.5 m. In a perfect TOF system with no noise, the various plot points would fall on the parallel segment lines. The distance from the plot points to the nearest segment line is a measure of the noise present on the acquired phase data. The singular points falling along the vertical or horizontal axis at about 6.2 radians may be regarded as degenerate segment lines.

In the plot depicted in FIG. 6, sequence d[i] is defined by equation (8) with dₘᵢₙ=0 m. Let the ratio

$$\frac{{f}_{2}}{{f}_{1}} = \frac{{m}_{1}}{{m}_{2}} \qquad ( 12 )$$

be chosen so that m₁ and m₂ are integers co-prime to each other. The plot of φ_{w2}(φ_{w1}) will span a [0,2π[×[0,2π[ square with a sequence of m₁+m₂−1 segments, which are termed indicator segments herein. (The bracket notation [0,2π[ is used because 0 and 2π are essentially the same point due to phase wrapping, and wrapped point 2π may safely be excluded from the interval.) The trace left by the point of coordinates (φ_{w1},φ_{w2}) as d[i] progresses from 0 to dₘₐₓ starts at the origin and passes through the origin again at the new wrapping distance U₁₂

$${U}_{12} = \frac{c}{2 {f}_{2}} {m}_{1} = \frac{c}{2 {f}_{1}} {m}_{2} . \qquad ( 13 )$$

Given a measurement (\tilde{φ}_{w1},\tilde{φ}\tilde{φ_{w2}}) corrupted by noise, if one can correctly estimate the indicator segment to which the noiseless point (φ_{w1},φ_{w2}) belongs, then the two phases shall have been effectively unwrapped. In doing so, magnitude of the wrapping distance is advantageously extended from

$$\frac{c}{2 {f}_{1}} to \frac{c}{2 {f}_{1}} {m}_{2} .$$

The indicator segment preferably is found by first computing the orthogonal distance between the measured point and each of the lines containing the segments. The closest such line uniquely determines indicator functions for the two frequencies. Referring, for example, to FIG. 6, where two modulation frequencies were used, the wrapping segments are drawn as parallel sloped lines, the indicator functions defined by each segment are given by Table 1 as:

TABLE 1

| Segment index | | |
|---|---|---|
| (from left to right) | n₁ | n₂ |
| 0 | 2 | 2 |
| 1 | 1 | 1 |
| 2 | 0 | 0 |
| 3 | 2 | 3 |
| 4 | 1 | 1 |
| 5 | 0 | 1 |

For example, Table 1 indicates that for segment index 0, each modulation frequency adds two cycles of 2π to provide the desired unwrapping. For segment index 1, each modulation frequenices add one cycle of 2π to provide the desired unwrapping, etc.

The unwrapped measurements are thus given by

φⱼ[i]=φ_{wj}[i]+2πnⱼ[i], (14)

j=1,2. (15)

In addition to the segments noted by the parallel sloped lines in FIG. 6, degenerate segments given by the points with coordinates (2π,0) and (0,2π) also exist. Note that if m₁ and m₂ were chosen as m₂=m₁±1, by way of example, good noise rejection is achieved since the segments will partition the square area in diagonal stripes of equal stripe width. It is perceived that tradeoffs exist between m₁, m₂, wrapping distance U₁₂ and noise variances σ₁ and σ₂.

A further optimization can be realized by rotating the indicator segments such that they are parallel with the x-axis. This optimization reduces the two-dimensional “closest line problem” to a single dimensional “closest point problem”. As such, the optimal indicator segment can then be found by simply identifying the segment closest to the point on the x-axis. This approach can be extended to N dimensions (N≧2), effectively reducing the scope of the problem from N dimensions to N−1 dimensions. The details of this optimization are described later for the case N=3.

Embodiments of the present application extend the above-described two frequency method to use of three modulation frequencies, f₁, f₂, and f₃, as follows.

f₁=αm₁,

f₂=αm₂,

f₃=αm₃,

where m₁, m₂ and m₃ are co-prime to each other and are preferably small integers. If there is a common denominator between the various modulation frequencies fᵢ, that term would be extracted and multiplied by the coefficient α. The coefficient α (units typically MHz) is related to the maximum unambiguous range dₘₐₓ. By way of example if α=15 MHz then dₘₐₓ=10 M. Small integers work well with embodiments of the present application, but possibly other approaches would function where m₁, m₂, and m₃ were not small integers. There may exist a more general but less optimal solution, in which these modulation frequencies are not required to be prime to each other. Table 2 depicts some of the interplay between m₁, m₂, and m₃ and α.

TABLE 2

| | |
|---|---|
| [m₁ + m₂ + m₃] · α/3 | TOF system measurement accuracy increases |
| | with increases in this ratio, and TOF |
| | system noise decreases with increase |
| | in this ratio |
| α | As α decreases, unambiguous range |
| | dₘₐₓ increases |
| m₁, m₂, m₃ - distance | The larger the sphere size (see FIG. 7B, |
| between each of the | 7C), the more robust the algorithm can be |
| points following rotation | |
| depends upon the | |
| relationship of m₁, m₂, | |
| m₃ to each other. The | |
| relationship defines the | |
| sphere size (see FIG. | |
| 7B) | |

For the case of three modulation frequencies that are co-prime to each other, one can show that the wrapping distance U₁₂₃ is:

$${U}_{123} = \frac{c}{2 α} . \qquad ( 16 )$$

There are a total of m₁+m₂+m₃−2 wrapping segments lying inside the [0,2]×[0,2π]×[0,2π] cube parallel to v, where:

$$v = [ \begin{matrix}{m}_{1} \\ {m}_{2} \\ {m}_{3}\end{matrix} ] , \qquad ( 17 )$$

and therefore (φ₁,φ₂,φ₃) can be projected onto the plane orthogonal to v. One of many possible ways of building this projection involves consideration of the rotation that brings the φ₃ coordinate axis parallel to v. The axis of this rotation is parallel to the vector n,

$$n = [ \begin{matrix}{m}_{2} \\ - {m}_{1} \\ 0\end{matrix} ] , \qquad ( 18 )$$

and orthogonal to both v and k, the direction of φ₃. The angle of rotation is defined by:

$$cos ( θ ) = \frac{k \cdot v}{\vert v \vert} = \frac{{m}_{3}}{\sqrt{{m}_{1}^{2} + {m}_{2}^{2} + {m}_{3}^{2}}} . \qquad ( 19 )$$

The rotation vector ω is thus given by:

$$ω = arccos ( \frac{{m}_{3}}{\sqrt{{m}_{1}^{2} + {m}_{2}^{2} + {m}_{3}^{2}}} ) \frac{n}{\sqrt{{m}_{1}^{2} + {m}_{2}^{2}}} . \qquad ( 20 )$$

One can use Rodrigues' formula to write the expression for the rotation matrix R as

$$R = {I}_{3} + sin ( \vert ω \vert ) X ( \frac{ω}{\vert ω \vert} ) + ( 1 - cos ( \vert ω \vert ) ) {X ( \frac{ω}{\vert ω \vert} )}^{2} , \qquad ( 21 )$$

where I₃ is the 3×3 identity matrix and X(w) is the skew-symmetric matrix defined as:

$$X ( w ) = [ \begin{matrix}0 & - {w}_{3} & {w}_{2} \\ {w}_{3} & 0 & - {w}_{1} \\ - {w}_{2} & {w}_{1} & 0\end{matrix} ] . \qquad ( 22 )$$

How then to compute the three-dimensional coordinates for the indicator segments end-points, and how to computer values of the indicator functions for the case of three modulation frequencies m₁, m₂, m₃. Consider the following exemplary three-dimensional coordinate and indicator function algorithm that can be stored in memory and executed by a processor included in electronic system 100 and/or in system 50′; see FIG. 3. Let the algorithm inputs be m₁, m₂, m₃ and let the algorithm outputs be P_{X,i}, P_{Y,i}, P_{Z,i}, N_{1,i}, N_{2,i}, N_{3,i} (i=1, . . . , m₁+m₂+m₃−2). The exemplary algorithm may be written as follows:

```
INPUTS: m₁, m₂, m₃
OUTPUTS: P_{X,i}, P_{Y,i}, P_{Z,i}, N_{1,i}, N_{2,i}, N_{3,i} (i = 1, . . . , m₁ + m₂ + m₃ − 2)
i = 1
n_{φ,X} = 0; n_{φ,Y} = 0; n_{φ,Z} = 0
n₁ = 0; n₂ = 0; n₃ = 0
while (i <= m₁ + m₂ + m₃ − 2)
  N_{1,i} = n₁; N_{2,i} = n₂; N_{3,i} = n₃
  ${P}_{X , i} = \frac{2 π {n}_{ϕ , X}}{{m}_{2} {m}_{3}}$
  ${P}_{Y , i} = \frac{2 π {n}_{ϕ , Y}}{{m}_{1} {m}_{3}}$
  ${P}_{Z , i} = \frac{2 π {n}_{ϕ , Z}}{{m}_{1} {m}_{2}}$
  while (n_{φ,X} < m₂m₃) and (n_{φ,Y} < m₁m₃) and (n_{φ,Z} < m₁m₂)
    n_{φ,X} = n_{φX} + 1;
    n_{φ,Y} = n_{φ,Y} + 1;
    n_{φ,Z} = n_{φ,Z} + 1;
  end
  if (n_{φ,X} == m₂m₃)
    n₁ = n₁ + 1;
    n_{φ,X} = 0;
  end
  if (n_{φ,Y} == m₁m₃)
    n₂ = n₂ + 1;
    n_{φ,Y} = 0;
  end
  if (n_{φ,Z} == m₁m₂)
    n₃ = n₃ + 1;
    n_{φ,Z} = 0;
  end
  i = i + 1;
end
```

Once the three-dimensional points with coordinates (P_{X,i}, P_{Y,i}, P_{Z,i}) are known, they can be projected onto the plane orthogonal to vector v defined in Eq. (17) using, for example, matrix equation (23):

$$[ \begin{matrix}{p}_{X , i} \\ {p}_{Y , i} \\ {p}_{Z , i}\end{matrix} ] = R [ \begin{matrix}{P}_{X , i} \\ {P}_{Y , i} \\ {P}_{Z , i}\end{matrix} ] . \qquad ( 23 )$$

FIG. 7A is useful to better understand the preferred methodology, according to embodiments of the present application. FIG. 7A depicts non-axis aligned points having two-dimensional coordinates (p_{X,i}, p_{Y,i}) when the preferably three modulation frequencies have relative values m₁=3, m₂=4, m₃=5. A three-dimensional or cubic form is depicted because N=3. Notice that in addition to the m₁+m₂+m₃−2 points defined by Eq. (23), one may also consider the six remaining projections of the vertices of the cube indicated by small triangles in FIG. 7A. Specific derivation of the two-dimensional coordinates of these points is very similar to the above-described calculation. Details are omitted herein as methods of derivation regarding these points are known to those skilled in the relevant art.

There exists a rotation matrix R′ε{R} that rotates the projected indicator segment end points pᵢ such that the pᵢ closest to the origin that is not the origin itself is rotated such that it is aligned with the x-axis. Let pᵢ′ denote these axis-aligned indicator segment end points:

pᵢ′=R′pᵢ=R′RPᵢ (24)

Let pᵢ denote projected indicator segments endpoint i with coordinates (p_{Xi},p_{Yi}), and let R denote the rotation matrix used to rotate the indicator endpoint segments. An exemplary algorithm to solve for R′ given inputs pᵢ and R may be written as follows:

$$a = arg {min}_{i} ( \sqrt{{p}_{Xi}^{2} + {p}_{Yi}^{2}} ∀ i : {p}_{i} \neq ( 0 , 0 ) ) \\ ɛ = \sqrt{{p}_{Xa}^{2} + {p}_{Ya}^{2}} \\ R = \frac{1}{ɛ} [ \begin{matrix}{p}_{Xa} & {p}_{Ya} & 0 \\ - {p}_{Ya} & {p}_{Xa} & 0 \\ 0 & 0 & ɛ\end{matrix} ] \qquad ( 25 )$$

In the case of multiple α values, α can be chosen arbitrarily from these values.

The above-mentioned two-dimensional closest point problem involved finding the nearest indicator point (p_{X,i}, p_{Y,i}) closest to (φ_{1w},φ_{2w}). This optimization advantageously reduces that problem to a pair of single dimensional closest point problems, for which the nearest indicator point pᵢ′, closest to φ_{w}′ can be found by simply identifying the set of indicator points closest to the φ_{w}′ on the y-axis, followed by finding the closest point to φ_{w}′ on the x-axis from that set of points. An exemplary algorithm is as follows:
Find the nearest p_{Yi}′ to φ_{2w}′ ( Y̅ is the set of all i satisfying the equation below)

$$\overline{Y} = \{ {arg min}_{i} ( \sqrt{{( {p}_{Yi} - {ϕ}_{2 w}^{′} )}^{2}} ∀ i ) \} \qquad ( 26 )$$

Find the nearest p_{Xi}′ to φ_{1w}′: iε Y̅ ( X̅ is the set of all i satisfying the equation below)

$$\overline{X} = \{ {arg min}_{i} ( \sqrt{{( {p}_{Xi} - {ϕ}_{1 w}^{′} )}^{2}} ∀ i ∈ \overline{Y} ) \} \qquad ( 27 )$$

In the case of multiple values of i in X̅ (i.e., if the axis-aligned input point (φ_{1w}′,φ_{2w}′) is equidistant between two indicator points pᵢ in the x-dimension), i can be chosen arbitrarily from these values.

It can be shown that this method correctly solves the closest-point point problem for all points within radius ε from any indicator segment endpoints, where 2ε is the smallest distance between any pair of endpoints.

Turning now to FIG. 7B, depicted are sixteen axis-aligned points, p₁, p₂, p₁₆ surrounded by spheres having radii d₄. A three-dimensional or cubic form is depicted as N=3 modulation frequencies are used. In FIG. 7B noise on the phase data constrains the magnitude of the radii d₄, and consequently adjacent spheres do not touch. Data points falling within the gray shaded volume within the cube surrounding the spheres are error prone, due to noise. A more ideal case would allow the radii to increase to magnitude ε, in which case adjacent spheres would touch.

By contrast, FIG. 7C shows a similar depiction, but wherein the permissible radii of the spheres surrounding the sixteen points have grown to magnitude ε. This is a more optimum case and the increased sphere radii represent reduced noise, or higher confidence in the phase data point. A data rejection mechanism (described with respect to FIG. 8, and with respect to FIG. 10, steps 340 and 350) has been employed to yield the more optimum case shown in FIG. 7C. Comparing FIG. 7B with FIG. 7C, a data point in FIG. 7B falling a distance ε from the computed point will be rejected as being too distant. But the same point in FIG. 7C will be accepted as having met a threshold or other validity criterion. In essence the radial distance to such remote points from the center of the nearest sphere is calculated and compared to a diameter threshold. The spheres with radii ε represent the region of points satisfying the threshold criterion for reliability or acceptance as valid data.

As this juncture, it is useful to describe a more final version of a preferred phase unwrapping algorithm. This algorithm preferably is stored in memory in electronics module 100 and preferably is executable therein by processors associated with module 100. Alternative some or all of the storage and execution of this algorithm may occur in system 50′; see FIG. 3.

Inputs to this phase unwrapping algorithm are the three wrapped phase values measured at the phase modulation frequencies f₁, f₂, f₃, the indicator points of the projections p_{X,i}, p_{Y,i}, and the values of the indicator functions N_{1,i}, N_{2,i}, N_{3,i} returned by the above-described exemplary three-dimensional coordinate and indicator function algorithm. The exemplary phase unwrapping algorithm may be represented as follows:

$$INPUTS \text{:} {m}_{1} , {m}_{2} , {m}_{3} , {p}_{X , i} , {p}_{Y , i} , {N}_{1 , i} , {N}_{2 , i} , {N}_{3 , i} , R \\ {Φ}_{1 w} , {Φ}_{2 w} , {Φ}_{3 w} \\ OUTPUTS \text{:} {Φ}_{1 u} , {Φ}_{2 u} , {Φ}_{3 u} \\ [ \begin{matrix}{ϕ}_{1 w} \\ {ϕ}_{2 w} \\ {ϕ}_{3 w}\end{matrix} ] = R [ \begin{matrix}{Φ}_{1 w} \\ {Φ}_{2 w} \\ {Φ}_{3 w}\end{matrix} ] \qquad ( 28 )$$

Find the index i of the indicator point (p_{X,i}, p_{Y,i}) closest to (φ_{1w},φ_{2w}) and finally, compute:

Φ₁ᵤ=Φ_{1w}+2πN_{1,i}

Φ₂ᵤ=Φ_{2w}+2πN_{2,i}

Φ₃ᵤ=Φ_{3w}+2πN_{3,i} (29)

It will be appreciated from the description of FIGS. 7A, 7B, and 7C that distance between the closest indicator point and the input point is a function of miscorrelation between the reported phases φᵢ from each of the modulation frequencies mᵢ. This error is roughly proportional to the jitter on each modulation frequency. Jitter is defined herein as the temporal standard deviation, and is a measurement of magnitude of noise on the phase input. Noise sources include shot noise, thermal noise, multipath noise (due to partial reflection of optical energy from the source target).

An additional source of error can result from motion blur if target object 20 moves during data acquisition by TOF system 10′ (see FIG. 3). If TOF system 10′ is operating with N=3 modulation frequencies, such motion blur error will occur across three distinct frames of image data, captured with the three distinct modulation frequencies. An image is captured at each modulation frequency, but the image may have moved between captures. Referring to FIGS. 7B, 7C and 8, in some embodiments motion blur errors can be detected by reducing the level of confidence associated with data point, literally reducing the radii ε of spheres of confidence centered on data points (see FIG. 7C). As such radii are reduced, it becomes easier to test to see what points now fall outside the reduced spheres of confidence. Such now exposed points can thus detect the presence and a measure of magnitude of motion blur. Such knowledge is useful in attempting to compensate for motion blur, perhaps by disregarding data now known to be blurred data.

With reference to FIG. 8, embodiments of the present application preferably define a zone using a threshold based on the distance of a given point to the closest indicator segment. Output points from a dealiasing algorithm that fall within the zone are marked as valid, whereas points falling outside the zone are marked as invalid. A point is said to be within the zone if the distance to the closest indicator point is below a given threshold, as defined by the zone. Preferably, the zone is varied dynamically based on amplitude as the signal/noise characteristics of the pixel array sensor change with signal amplitude.

FIG. 8 depicts an exemplary relationship between jitter and signal amplitude for an exemplary TOF system 10′ (see FIG. 3) operating with modulation frequency f=88 MHz. The plot in FIG. 8 may also be generated using data collected under ambient light condition, for which the jitter would be higher compared to normal condition. For example if TOF system 10′ were operated in a room with high ambient light condition, jitter would be higher than if system 10′ were operated under normal light condition. FIG. 8 also depicts exemplary static and dynamic zones. In embodiments of the present application, the static zone is defined preferably using a constant threshold, while the dynamic zone is defined using a varying threshold based on signal amplitude. With reference to the static zone depicted in FIG. 8, data exhibiting say less than 10° of jitter may be accepted and labeled as valid or good data, while data exhibiting greater than 10° of jitter may be labeled as bad or invalid data and discarded. Alternatively a more sophisticated dynamic threshold can be adopted as suggested by the dynamic zone shown in FIG. 8. Data having jitter less than that associated with a region denoting the dynamic zone can be accepted or labeled as good or valid data, while data points above the dynamic zone can be rejected or labeled as bad or invalid data. With reference to FIG. 7C, a higher dynamic zone threshold allows in more data; the depicted larger sphere radius implies use of a greater threshold applied to data with low signal amplitude. The lower threshold of the dynamic zone is depicted in FIG. 7B, in which a smaller sphere radius implies a tighter threshold applied to data with higher signal amplitude. Thus smaller sphere radius is associated with high signal amplitude data that is less noisy and should not be filtered out. While these defining mechanisms work well in practice, other mechanisms for defining and implementing static and dynamic zones could be employed.

Given outputs from a dealiasing algorithm, embodiments of the present application compute a dealiasing error preferably based on deviation from the actual distance from the TOF system sensor array to an imaged object in the scene, also known as the ground truth. In a perfect TOF system the ground truth would be identical to the TOF system measured depth distance.

Magnitude of acceptable deviation is preferably based on the particular application for which TOF system 10′ is used. Dealiasing algorithm outputs can be labeled as ‘correct’ or as ‘incorrect’, manually using human judgment, or can be labeled automatically by bounding the noise using a pre-defined specification. Other methods for labeling dealiasing algorithm outputs could instead be used.

Given the list of correct and incorrect points, embodiments of the present application preferably tune a static zone or a dynamic zone by minimizing false positives and maximizing true positives. As used herein, false positives are outputs with incorrect depth (d values) that have not been marked as invalid outputs. As used herein, true positives are outputs that have correct depth (d values) and are not marked as invalid outputs. A TOF system 10′ receiver operating characteristic (ROC) curve can be plotted using the above information. The zone corresponding to the point on the ROC curve that maximizes true positives and minimizes false positives is preferably selected for optimum performance. A detailed description is not presented herein as selection methods are known to those skilled in the relevant art.

FIG. 9 is a flow chart depicting initialization method steps used to identify indicator points and corresponding aliasing intervals for TOF system 10′. Preferably algorithm(s) used to carry out the method steps in FIG. 9 are stored and executed within module 100 in system 10′ although some steps could instead by carried out within module 50′ (see FIG. 3). The steps shown in FIG. 9 may only be executed once, unless subsequently a modulation frequency for TOF system 10′ is changed. The initialization method depicted in FIG. 9 gathers information to build tables of data for use in computing unwrapped phases. FIG. 10, described later herein, is directed generally to computing the unwrapped phases.

In FIG. 9 at method step 200, indicator segments are identified, preferably by module 100 using for example the algorithm described with respect to equation (23). For a three modulation frequency system, method step 200 receives as inputs the N=3 wrapped phase values measured at phase modulation frequencies f₁, f₂, f₃, indicator points of the projections p_{X,i}, p_{Y,i}, as well as values of the indicator functions N_{1,i}, N_{2,i} N_{3,i}. Once method step 200 has identified the indicator segments, method step 210 computes a rotation matrix, using for example the method discussed with respect to equation (21). At method step 220, the rotation is applied to the wrapped phases. Employing appropriate rotation advantageously enables what is a three-dimensional analysis to be reduced to a simpler two-dimensional analysis, with commensurate reduction in processing overhead and processing time.

Method step 220 can be followed directly by method step 230, in which identification of the indicator points and corresponding intervals occurs. Such identification may be carried out using the analysis described with respect to equations (29). Once the indicator points have been identified and their segment number ascertained, a look-up table of data, stored in module 100 or module 50′ (see FIG. 3) is consulted to learn how many cycles of 2π are to be added to unwrap the phase. Table 1 herein provides such information that may be used to unwrap each phase.

However optionally, method step 220 preferably will branch to carry out steps 240, 250, and 260 rather than proceed directly to step 230. At method step 240, an optimized rotation matrix is computed, preferably using the method described herein, culminating with equation (25). At method step 250, the optimized rotation matrix information determined in step 240 is applied to the indicator segments, preferably using the method described with respect to equation (24). Optionally but preferably, method step 260 may be used to compute a maximum sphere size, which can help optimize the analysis as suggested by a comparison between FIG. 7B and the more optimized state depicted in FIG. 7C. Sphere radius ε is associated with variance of noise, where a small radius is indicative of low noise in that all points fall within the sphere. In some embodiments thresholding, as indicated by FIG. 8, may be employed in this optimization step.

As noted, once the method steps depicted in FIG. 9 have been carried out and relevant data stored, e.g., in system 100, these method steps need not be repeated unless there is a change to one or more modulation frequencies. In practice, TOF systems may be operated for months or longer without need to alter the modulation frequencies. But if altered, then at least method steps 200, 210, 220, and 230 should be repeated to update data identifying indicator points and corresponding aliasing intervals. In practice, collectively the various method steps described in FIG. 9 can typically be executed in a few milliseconds or less.

Turning now to FIG. 10, the method steps described are carried out during real-time operation of TOF system 10′ for each phase input. Typically execution of the method steps shown in FIG. 10 is quite rapid, a few microseconds. Algorithm(s) to carry out the method steps shown in FIG. 10 preferably are stored in memory associated with module 100 and are executed by a processor in module 100. Alternatively, some or all storage and algorithm execution may occur within system 50′; see FIG. 3.

In FIG. 10, method step 300 receives the input point coordinate information from method step 230 (see FIG. 9) and projects these points onto a plane orthogonal to the vector v for use in appropriately rotating the input information. Method step 300 may be carried out as described with respect to equation (23). Rotation is applied on a per pixel basis to the phase output from each pixel in pixel sensor array 40 in TOF system 10′ (see FIG. 3).

At method step 310, closest indicator points are determined for the rotated data provided from method step 300. These determinations may be carried out as described with respect to equations (26) and (27). Advantageously rotation at step 300 simplifies calculations at step 310, as a three-dimensional analytical problem is reduced to a two-dimensional analysis.

Method step 310 may be followed directly by method step 320, in which phase unwrapping occurs, preferably by applying the unwrapping interval associated with each indicator point. Such unwrapping calculations may be carried out as described with respect to equation (29). Method step 320 is followed by method step 330 in which the unwrapped phases are averaged, since one value of distance d to the target object is desired, not three values. Since many noise components are random in nature, method step 330 advantageously reduces noise associated with the unwrapped phase information.

Optionally, however, method step 310 may be followed by method steps 340 and 350, which help implement the labeling of data indicated in FIG. 8. Method step 340 finds the distance d to the closest indicator point, and then at step 350 each such indicator point is labeled as valid or invalid. As described with respect to FIG. 8 thresholding may be employed in the labeling of the indicator points. Information from method steps 340 and 350, if these steps are practiced, in coupled to method step 320.

The foregoing analytical technique enables dynamic modification of modulation frequencies to unwrap and thus disambiguate phase. As noted, preferably processing and software used to carry out this analysis is performed by module 100 and/or components of TOF system 10′; see FIG. 3. The ability to dynamically fine tune modulation frequencies in real-time enhances overall performance of TOF system 10′. Such dynamic fine tuning enables the TOF system to acquire depth data at relatively high modulation frequencies fᵢ, while maintaining acceptably large unambiguous imaging ranges dₘₐₓ. If dynamic fine tuning occurs and at least one modulation frequency becomes modified, then the method steps of FIG. 9 should be carried out again, and tables of new data generated and stored. The method steps of FIG. 10 preferably occur during real-time operation of TOF system 10′ without regard to changes in any modulation frequency.

While increasing the number (N) of modulation frequencies will yield a greater wrapping distance dₘₐₓ in practice use of N=3 modulation frequencies can provide acceptable TOF system performance. In one embodiment, TOF system 10′ acquires image data using modulation frequencies of 97 MHz, 115 MHz, and 125 MHz to obtain an unambiguous range distance dₘₐₓ of about 15 M, using a 5 W optical emitter 30 (see FIG. 3). It will be appreciated that this reasonably large dₘₐₓ is obtained while operating the TOF system using relatively high frequency modulation frequencies.

Modifications and variations may be made to the disclosed embodiments without departing from the subject and spirit of the application as defined by the following claims.

What is clamed is:

1. A method to unwrap phase ambiguity in a phase-type time of flight (TOF) system that acquires phase data at N modulation frequencies fᵢ such that phase data φᵢ is acquired using modulation frequency fᵢ, and that measures distance d to a target object, the method comprising the following steps:
(a) identifying indicator segments for said N modulation frequencies, wherein each indicator segment is associated with an aliasing interval and with a wrapped phase;
(b) acquiring phase data during an exposure time T, sub-divisible into N segments, using said N modulation frequencies fᵢ such that during an iₜₕ acquisition phase, phase data φᵢ is acquired using modulation frequency fᵢ; and
(c) determining which of said indicator segments is most closely associated with acquired said phase data;
wherein a most closely associated indicator segment determined at step (c) is used to determine an unwrapped phase and unambiguous said distance d.

2. The method of claim 1, further using modulation frequencies fᵢ=αmᵢ where mᵢ are co-prime integers.

3. The method of claim 1, further including at least one of:
(d) determining unwrapped distance from at least one most closely associated indicator segment determined at step (c); and
augmenting step (a) to further include at least one additional step of (i) computing a rotation matrix that allows identified indicator segments to appear as points, and applying rotation thus computed to wrapped phases, and (ii) computing a rotation matrix that allows identified indicator segments to appear as points.

4. The method of claim 1, wherein step (a) is carried out when said TOF system is off-line.

5. The method of claim 3, wherein step (a) is so augmented, and wherein step (a) further includes at least one of:
(ai) associating spheres having radii ε with said indicator points, wherein size of said ε is maximized to expose and identify phase data of low confidence;
(aii) associating spheres having radii ε with said indicator points, wherein size of said ε is maximized to expose and identify phase data of low confidence, wherein maximum size of said ε has a characteristic selected from a group consisting of (I) size of said ε is constant, and (II) size of said ε is computed as a function of signal amplitude of acquired said phase data;
(aiii) labeling phase data as one of valid and invalid based on distance to said indicator point; and
(aiv) labeling phase data as one of valid and invalid based on whether distance to a nearest said indicator point is greater than size of said radii ε.

6. The method of claim 1, wherein step (c) further includes at least one step of:
(i) rotating acquired phase data, and finding a closest indicator point;
(ii) rotating acquired phase data, finding a closest indicator point, and finding distance to said indicator point.

7. The method of claim 3, wherein claim 3 includes (d) determining unwrapped distance from at least one most closely associated indicator segment determined at step (c);
step (a) includes acquiring N=3 unwrapped phases φ₁, φ₂, and φ₃; and
step (d) further includes calculating a weighted average of said three unwrapped phases.

8. The method of claim 7, further including:
discerning a measure of confidence among data points associated with wrapped said phases φ₁, φ₂, and φ₃;
labeling said data points associated with a higher measure of confidence as valid;
labeling remaining data points as invalid; and
varying a threshold of confidence to test for invalid points such that phase error due to movement of said target object is identified as motion blur error.

9. A system to unwrap phase ambiguity in data acquired by a phase-type time of flight (TOF) system that acquires phase data at N modulation frequencies fᵢ such that phase data φᵢ is acquired using modulation frequency fᵢ, and that measures distance d to a target object, the system including:
means for identifying indicator segments for said N modulation frequencies, wherein each indicator segment is associated with an aliasing interval and with a wrapped phase, said means for identifying operable when said TOF system is off-line;
means for controlling said TOF system such that said TOF system acquires phase data during an exposure time T, sub-divisible into N segments, using said N modulation frequencies fᵢ such that during an iₜₕ acquisition phase, phase data φᵢ is acquired using modulation frequency fᵢ; and
means for determining which of said indicator segments is most closely associated with acquired said phase data;
wherein a most closely associated one of said indicator segments is used to determine an unwrapped phase and unambiguous said distance d.

10. The system of claim 9, wherein said TOF system acquires phase data using modulation frequencies fᵢ=αmᵢ where mᵢ are co-prime integers.

11. The system of claim 9, further including:
a module to determine unwrapped distance from at least one most closely associated indicator segment determined by said means for determining.

12. The system of claim 9, wherein said means for identifying further includes:
a first module to compute a rotation matrix that allows identified indicator segments to appear as points; and
a second module to apply rotation computed by said first module to wrapped phases;
wherein said first and second module have a characteristic selected from a group consisting of (I) said first module is separate from said second module, and (II) said first module and said second module are one module.

13. The system of claim 11, wherein said means for determining further computes an optimized said rotation matrix.

14. The system of claim 12, wherein said means for determining further includes at least one of:
means for associating spheres having radii ε with said indicator points, wherein size of said ε is maximized to expose and identify phase data of low confidence;
means for associating spheres having radii ε with said indicator points, wherein size of said ε is maximized to expose and identify phase data of low confidence, wherein maximum size of said ε has a characteristic selected from a group consisting of (I) size of said ε is constant, and (II) size of said ε is computed as a function of signal amplitude of acquired said phase data;
means for labeling phase data as one of valid and invalid based on distance to said indicator point; and
means for labeling phase data as one of valid and invalid based on whether distance to a nearest said indicator point is greater than size of said radii ε.

15. The system of claim 9, wherein said means for determining further carries out at least one (i) rotating acquired phase data, and finding a closest indicator point, and (ii) rotating acquired phase data, finding a closest indicator point, and finding distance to said indicator point.

16. The system of claim 14, wherein said TOF system acquires N=3 unwrapped phases φ₁, φ₂, and φ₃, further including:
means for discerning a measure of confidence among data points associated with wrapped said phases φ₁, φ₂, and φ₃;
means for labeling said data points associated with a higher measure of confidence as valid, and labeling remaining data points as invalid; and
a module to vary a threshold of confidence to test for invalid points such that phase error due to movement of said target object is identified as motion blur error;
wherein said means for discerning and said means for labeling have a characteristic selected from a group consisting of (I) said means for discerning is separate from said means for labeling, and (II) said means for discerning and said means for labeling comprise a single module.

17. A phase-base time-of-flight (TOF) system with enhanced ability to unwrap phase ambiguity to measure distance d to a target object using phase data, the TOF system acquiring phase data at N modulation frequencies fᵢ=αmᵢ where mᵢ are co-prime integers, such that phase data φᵢ is acquired using modulation frequency fᵢ the TOF system including:
means for identifying indicator segments for said N modulation frequencies, wherein each indicator segment is associated with an aliasing interval and with a wrapped phase, said means for identifying operable when said TOF system is off-line;
means for controlling said TOF system such that said TOF system acquires phase data during an exposure time T, sub-divisible into N segments, using said N modulation frequencies fᵢ such that during an iₜₕ acquisition phase, phase data φᵢ is acquired using modulation frequency fᵢ;
means for determining which of said indicator segments is most closely associated with acquired said phase data; and
a module to determine unwrapped distance from at least one most closely associated indicator segment determined by said means for determining;
wherein a most closely associated one of said indicator segments is used to determine an unwrapped phase and unambiguous said distance d.

18. The TOF system of claim 17, wherein said means for determining subjects identified indicator segments to rotation such that they appear as indicator points, and applies rotation to wrapped phases, wherein rotation has a characteristic selected from a group consisting of (I) rotation is optimal, and (II) rotation is less than optimal.

19. The TOF system of claim 18, further including:
a module to associate spheres having radii ε with said indicator points,
wherein size of said ε is maximized to expose and identify phase data of low confidence;
said module further associating spheres having radii ε with said indicator points, wherein size of said ε is maximized to expose and identify phase data of low confidence, wherein maximum size of said ε has a characteristic selected from a group consisting of (I) size of said ε is constant, and (II) size of said ε is computed as a function of signal amplitude of acquired said phase data;
said module further labeling phase data as one of valid and invalid based on distance to said indicator point; and labeling phase data as one of valid and invalid based on whether distance to a nearest said indicator point is greater than size of said radii ε.

20. The TOF system of claim 19, further including:
a first module to discern a measure of confidence among data points associated with each wrapped phase φᵢ;
a second module labeling said data points associated with a higher measure of confidence as valid, and labeling remaining data points as invalid; and
a third module to vary a threshold of confidence to test for invalid points such that phase error due to movement of said target object is identified as motion blur error;
wherein said first module, said second module, and said third module have at least one characteristic selected from a group consisting of (i) at least two of said first module, said second module, and said third module are a single module, and (ii) said first module is separate from said third module.
